(19) United States
(12) Patent Application Publication
(10) Pub. No.: US 2026/0259558 A1
(43) Pub. Date: Sep. 3, 2026

(54) METHOD TO CONTROL A MOVEMENT OF A ROBOT AND A CONTROLLER

(71) Applicant: ANYBOTICS AG, Zürich (CH)

(72) Inventors: Florent Mennechet, Zürich (CH); Christian Gehring, Winterthur (CH)

(21) Appl. No.: 18/878,362

(22) PCT Filed: Jun. 29, 2022
(86) PCT No.: PCT/EP2022/067936

§ 371 Date: Dec. 23, 2024

(51) Int. Cl. G05D 1/223; G05D 1/224; G05D 109/12; G06F 3/0484; G06F 3/0488

(52) U.S. Cl. CPC G05D 1/2232; G05D 1/2242; G05D 2109/12; G06F 3/0484; G06F 3/0488

(57) ABSTRACT

A method to control a movement of a robot (100), in particular a legged robot, comprising a controller (1) with a user interface unit configured to receive a user command for controlling a robot movement by applying an actuator command \vec{c}=f(v, w) to an actuator of the robot (100). The user interface unit comprises a touch sensitive surface (10). The method comprises the steps of touching the touch sensitive surface (10) and thereby setting a new point of origin (x₀, y₀) of a user reference frame (x, y), while staying in touch with the touch sensitive surface (10), generating a user command (x1, y1) within the user reference frame (x, y), and translating the user command (x1, y1) into the actuator command t, with v=f1(y1) and w=f2(x1) and into the robot movement, wherein v and w each correspond to one velocity out of the velocities of a robot reference frame (x_{R},y_{R},z_{R}).

### TECHNICAL FIELD

The invention refers to a method to control a movement of a robot, a controller therefore and a use of the controller.

### BACKGROUND ART

Robots are used for various tasks, in particular for supporting human work in various environments. The robot movements are thereby controlled and steered by a controller.

In particular, if a robot is acting in a hazardous environment, the operator steering the robot needs to pay full attention to the robots movements to prevent damage of the robot or its environment.

The steering of a robot in a hazardous environment can therefore be very demanding and requires a controller that can be handled easily. Preferably, such a controller can be operated without even having visual control of the controller itself. This functionality is implemented by having joystick-like elements on the controller that allow to steer the robot by just moving the joystick-like elements with the fingers and no need of visual control of the elements due to the haptic feedback that is provided by the joystick-elements.

The disadvantage of such a controller is of course its single-purpose application. Living in a world where devices are expected to have multi-purpose applications, a classic controller with joysticks that are dedicated to only one functionality is not convenient anymore.

A more convenient way is it to integrate such a controller as an application in a smartphone, tablet or pc device by means of using a touch sensitive surface functionality or touch screen of the respective device. Such integration would require to operate the controller via a touch sensitive surface or touch screen.

A further disadvantage of a known controller is that the steering with joystick-elements often requires both hands and/or multiple fingers to be on the controller. In particular, since such a controller might be heavy to carry, it is very disadvantageous if both hands are needed to control it, since then it is basically necessary to carry it by means of a neck holder or similar. In addition, in a hazardous environment, a user might wear gloves for steering the robot. A joystick-like element might be difficult to steer with gloves.

Therefore, advantageously, the steering should be possible with only one hand and in particular with only one finger, such that the controller can be carried with the other hand. In particular, if the user is wearing gloves, it is advantageous if the controller can be controlled by means of using only a single tactile device, such as a pen-like input device that can be used also with gloves.

Anyway, known methods or applications to control the robot via a touch sensitive surface or touch screen require the operator to have a visual control of the touch sensitive surface or touch screen since in contrast to a joystick-like controller, there is no haptic feedback anymore.

### DISCLOSURE OF THE INVENTION

The problem to be solved by the present invention is therefore to provide a method and application that allows an operator to control a robot in a hazardous environment with a tablet, smartphone or pc having a touch sensitive surface or touch screen, wherein there is no need of the operator to have visual control of the touch sensitive surface or touch screen.

In addition, the present invention further solves the problem to provide a method, wherein the controller can be operated by means of one finger or input device (tactile device).

The problem is solved by a first aspect of the invention referring to a method to control a movement of a robot, a second aspect referring to a controller to conduct the method, a third aspect referring to a computer program for carrying out the method and a use of the controller or computer program.

Unless otherwise stated, the following definitions shall apply in this specification:

The terms “a”, “an”, “the” and similar terms used in the context of the present invention are to be construed to cover both the singular and plural unless otherwise indicated herein or clearly contradicted by the context. Further, the terms “including”, “containing” and “comprising” are used herein in their open, non-limiting sense. The term “containing” shall include both, “comprising” and “consisting of”.

Advantageously, the term “torso of a robot” or “torso” refers to a main body of a robot comprising the logic components for controlling the robot and wherein the limb section or limb is attached to the torso. In particular, wherein the torso might comprise multiple limbs, e.g. for a quadruped robot.

Advantageously, the term “actuator command \vec{t}=f(v, w)” refers to a command that can be received by an actuator of a robot. In particular, if the robot is a legged robot, the one or more actuator that can receive the actuator command t are integrated in the one or more leg of the robot.

Advantageously, a legged robot can comprise various actuators integrated in each of its legs:
a hip abduction/adduction (HAA) actuator adapted to connect to the robot torso and connecting to a hip flexion/extension (HFE) joint,
the hip flexion/extension (HFE) joint connecting to a hip flexion/extension (HFE) actuator,
the hip flexion/extension (HFE) actuator connecting to the upper leg,
the upper leg connecting to a knee flexion/extension (KFE) actuator,
the knee flexion/extension (KFE) actuator connecting to a shank,
the shank connecting to a shank tube, and
the shank tube is adapted to connect to the robot foot or robot foot adapter which is adapted to connect to the robot foot.

Advantageously, the actuator command \vec{t} is a general term for all the actuator commands that are sent to the in particular legged robot. Therefore, the actuator command \vec{t} describes a signal that is sent to the robot to trigger an action of the robot, respectively a coordinated action of its actuators. In particular, the Advantageously, the “robot movement” corresponds to a movement direction of the robot that comprises the actuator that receives the actuator command \vec{t}.

Advantageously, the robot reference frame (x_{R},y_{R},z_{R}) is a coordinate frame related to a robot main body or robot torso. Within the robot reference frame (x_{R},y_{R},z_{R}), the robot can move with six velocities defined in the following:
a translational velocity \vec{tₓ} in heading direction x_{R} of the robot reference frame,
a translational velocity \vec{t_{Y}} in lateral direction y_{R} of the robot reference frame,
a translational velocity \vec{t_{z}} in vertical direction z_{R} direction of the robot reference frame,
an angular velocity \vec{aₓ} around the x_{R}-axis (roll-axis),
an angular velocity \vec{a_{Y}} around the y_{R}-axis (pitch-axis),
an angular velocity \vec{a_{z}} around the z_{R}-axis (yaw-axis).

Advantageously, the heading direction x_{R} refers to a direction in which the heading of the robot is pointing. Further particular, the heading direction x_{R} is the direction in which the legged robot is walking in a direction that corresponds to the longitudinal axis of its robot torso.

Further advantageously, the robot movement in lateral direction is lateral to the heading direction and corresponds to the robot movement in y_{R}-direction of the robot frame.

The first aspect of the invention refers to a method to control a movement of a robot, in particular a legged robot, comprising a controller. The controller has a user interface unit to receive a user command for controlling a robot movement by applying an actuator command \vec{c}=f(v, w) to an actuator of the robot.

Such an actuator is advantageously an actuator of a leg in a legged robot. In addition, such an actuator can be an actuator in any other type of robot.

The user interface comprises a touch sensitive surface, in particular a touch screen or touch pad. The touch sensitive surface can advantageously receive input via touch of a finger or input device, like a pen-like input device or any other tactile device or similar.

Advantageously, the method is related to a computer program running on a device like a tablet or smartphone or pc. Therefore, if the computer program is activated, the method runs on the respective device.

The method comprises the steps of
touching the touch sensitive surface and thereby setting a new point of origin (x₀, y₀) of a user reference frame (x, y), in particular for a cursor,
while staying in touch with the touch sensitive surface, generating a user command (x1, y1) within the user reference frame (x, y), in particular, while staying in touch with the touch sensitive surface, moving the cursor within the user reference frame (x, y) to input a user command (x1, y1),
translating the user command (x1, y1) into the actuator command \vec{c}, with

$$v = f 1 ( y 1 )$$

$$w = f 2 ( x 1 )$$

and therefore into the robot movement, wherein v and w each correspond to one velocity, in particular correspond to different velocities, selected out of the (six) velocities that a robot can take within the robot reference frame (x_{R},y_{R},z_{R}).

Advantageously, the user reference frame is a coordinate frame that is related to the touch sensitive surface, where the user can input commands. The commands are input by means of touching the touch sensitive surface and moving a finger or input device over the touch sensitive surface.

When a finger or input device first touches the touch sensitive surface, this position is referred to the point of origin (x₀, y₀) of the user reference frame. The position might be marked with a cursor. While staying in touch with the touch sensitive surface and moving the finger or input device over the touch sensitive surface, user commands (x1, y1) are generated that translate into an actuator command \vec{c}.

Advantageously, the term translate refers to a conversion of the signal by means of a computing unit.

Advantageously, a user command (x1, y1) is generated within an interval of 20 Hz to 40 Hz while moving the finger over the touch sensitive surface. Further advantageously, it could be defined that after each interval, a new user command (x1, y1) is defined.

In an advantageous embodiment of the invention, v corresponds to the translational velocity \vec{tₓ} in heading direction x_{R} of the robot reference frame and w corresponds to one out of the (five) remaining velocities in another dimension (y_{R},z_{R}) of the robot reference frame.

In a further advantageous embodiment of the invention, the method comprises the step of translating the user command (x1, y1) into the actuator command \vec{c}, wherein w corresponds to the angular velocity a_{z}, such that the movement of the robot results in yawing around the vertical axis z_{R} of the robot frame.

In an advantageous embodiment, the finger or input device is moved over a touch sensitive surface to generate a user command (x1, y1), which is translated into an actuator command \vec{c}=f(v, w), with v=f1(y1)=f1′(\vec{tₓ}) and w=f2(x1)=f2′(\vec{a_{z}}).

This means in particular that an actuator of the robot is steered to move in x_{R}-direction of the robot reference frame if the finger or input device is moved over the touch sensitive surface in y-direction of the user reference frame. If the finger or input device is moved over the touch sensitive surface in x-direction of the user reference frame, the actuator of the robot is steered to yaw around the vertical axis z_{R} with an angular velocity \vec{a_{z}}.

In particular, for an advantageous method, if the finger or input device is moved from (x₀, y₀) to (x1, y1), this might result in a combination, in particular a vector addition, of the two velocities \vec{tₓ} and \vec{a_{z}}.

In a further advantageous embodiment of the invention, the user command (x1, y1) is translated into an actuator command \vec{c}, and therefore into a robot movement wherein w corresponds to a translational velocity \vec{t_{Y}} in lateral direction y_{R} of the robot frame.

In a further advantageous embodiment, the finger or input device is moved over a touch sensitive surface, to generate a user command (x1, y1), which is translated into an actuator command \vec{c}=f(v, w), with v=f1(y1)=f1′(\vec{tₓ}) and w=f2(x1)=f2′(\vec{t_{Y}}).

This means in particular that an actuator of the robot is steered to move in x_{R}-direction of the robot reference frame if the finger or input device is moved over the touch sensitive surface in y-direction of the user reference frame. If the finger or input device is moved over the touch sensitive surface in x-direction of the user reference frame, the actuator of the robot is steered to move in a lateral y_{R} direction, lateral to the heading direction x_{R}.

In particular, if the finger or input device is moved from (x₀, y₀) to (x1, y1), this results in a combination of the two velocities \vec{tₓ} and \vec{t_{Y}}.

In a further advantageous embodiment of the invention, the robot movement stops, as soon as the finger or input device is removed from the touch sensitive surface, therefore as soon as a touch of the touch sensitive surface is released. This functionality makes it very intuitive for a user to stop the robot movement.

In a further advantageous embodiment of the invention, the method comprises the step of protecting commands indicated by the touch of the touch sensitive surface. As long as a finger or input device moves on the touch sensitive surface, no other functionality is triggered by touching the touch sensitive surface.

Advantageously, as long as a finger or input device moves on the touch sensitive surface, no other functionality is triggered by touching the touch sensitive surface from this finer or input device.

Advantageously, even if a second finger or second input device would touch the sensitive surface, this would not trigger another functionality than what the first touch of the surface started. Further advantageously, the protection against the involuntary “triggering” of other functions only involves the finger or input device which is first in touch with the sensitive surface and gives control commands, there is in particular no deactivation of other functions.

Therefore, advantageously, if the first finger or input device slides over the stop button during the steering, the stop button is protected. But the stop can still be triggered by a direct tap from second finger or input device.

To simplify, the finger in continuous contact involved in the robot control cannot trigger anything else

In a further advantageous embodiment of the invention, the user command (x1, y1) is only implemented into an actuator command \vec{c} if a movement of the cursor on the touch sensitive surface (10) extends over a buffer zone in x-direction and/or in y-direction. The buffer zone prevents that unintentional touches of the touch sensitive surface generate an actuator command \vec{c}.

Advantageously, the buffer zone
for the user command on a ±x-axis of the user reference frame is: 0.005 cm≤|x|0.5 cm,
for the user command on a ±y-axis of the user reference frame is: 0.005 cm≤|y|0.5 cm.

In a further advantageous embodiment of the invention, the sensitivity of the user reference frame (x, y) is adaptable. In particular, the sensitivity refers to the sensitivity respectively the interval of the scale of the x- and y-axis of the user reference frame. Alternatively, the variation in sensitivity might be implemented by having different sized buffer zones in x- and y-direction of the user reference frame.

The user command on the ±x-axis is 10 times more sensitive than the user command on the ±y-axis. In particular wherein the user command on the ±x-axis is 2 times more sensitive than the user command of the ±y-axis. This feature allows to adapt the sensitivity of the robot movements to the environment.

In a further advantageous embodiment of the invention, the scale on the ±x-axis of the user reference frame is not proportional to the scale on the ±y-axis of the user reference frame. In particular, this feature has also an influence on the sensitivity of the user reference frame. By having different proportionality between the x-axis and the y-axis, the sensitivity in x-direction and y-direction of the user reference frame might vary. In particular, the different proportionality means that the scales have different intervals and therefore, a movement of the finger or input device of a defined distance in x-direction of the user reference frame does not result in the same increase of the actuator command \vec{c} than the same touch movement of the defined distance in y-direction of the user reference frame.

In a further advantageous embodiment of the invention, an absolute scale of the ±x-axis and/or the ±y-axis of the user reference frame (x, y) is adaptable in size. This means, that the size of the x-axis and/or y-axis of the user reference frame might vary in size on the touch sensitive surface.

In a further advantageous embodiment of the invention, the user reference frame (x, y) is invertible, such that the user commend (x1, y1) is translated into the actuator command \vec{c} with v=−f1(y1) and w=−f1(x1).

This has the effect, that the steering of the robot actuator respectively robot is more intuitive. If the robot changes its movement direction, in particular has its heading direction directed towards the person controlling the robot, it might be more intuitive to inverse the steering directions, meaning that a touch movement of the finger or input device in −x-direction of the user reference frame on the touch sensitive surface results in a robot movement in heading direction x_{R} of the robot reference frame (x_{R},y_{R},z_{R}). In a further advantageous embodiment of the invention, the touch sensitive surface comprises a pre-defined area to set the new point of origin.

In a further advantageous embodiment of the invention, the switching between alternative method steps might be done by
touching the touch sensitive surface twice and staying in touch with the touch sensitive surface at the second touch to switch method steps, and/or
releasing the touch to the touch sensitive surface to return to the previous method step.

The technical effect of this feature is in particular that it can be switched easily between alternative method steps, without visual control of the touch sensitive surface and without having a look at the touch sensitive surface. Therefore, the focus of the user can still stay with the robot movement and robot.

The switching between alternative method steps refers in particular to switching between the method steps:
translating the user command (x1, y1) into the actuator command \vec{c}, wherein w corresponds to an angular velocity \vec{a_{z}}, and therefore into the robot movement of yawing around the vertical axis z_{R} of the robot frame, and/or
translating the user command (x1, y1) into the actuator command \vec{c}, and therefore into the robot movement, wherein w corresponds to a translational velocity \vec{t_{Y}} in lateral direction y_{R} of the robot frame, and/or
adapting the sensitivity of the user reference frame (x, y) such that the user command on the ±x-axis is 10 times more sensitive than the user command on the ±y-axis, or vice versa, in particular wherein the user command on the ±x-axis is 2 times more sensitive than the user command of the ±y-axis, or vice versa.

In a further advantageous embodiment of the invention, if the touch sensitive surface is a touch screen, the background colour of the touch screen changes according to the respective method.

Such a colour change of the touch screen or user reference can be noticed by the user in the corner of the eyes. Therefore, even though the user does not look at the touch screen, but still focus on the robot, the user might notice the colour change of the touch screen or user reference frame. Since a specific colour change might refer to a specific method step, the user always knows which method step the action he takes on the touch screen refers to at the moment.

In particular, if the colour is blue, this might be a signal that the present method step refers to the method step, wherein w corresponds to an angular velocity a_{z} (yawing). If the colour background is red, this might be a signal that the present method step refers to the method step, wherein w corresponds to a translational velocity t_{Y}.

In particular, the colour change relies on the peripheral vision of the user. The user, even though not looking directly on the touch screen, notices a colour change at the periphery of its visible perception of the environment. Therefore, the colour change basically replaces a haptic feedback, e.g. from a joystick-like control element, as it is known from prior art.

A second aspect of the invention refers to a controller to conduct the method according to the first aspect of the invention.

Advantageously, the controller is integrated into a table application, a smartphone application and/or a pc application.

A third aspect of the invention refers to a computer program for carrying out the method according to the first aspect, in particular with a controller according to the second aspect of the invention.

A fourth aspect of the invention refers to a use of the controller according to the second aspect or a computer program according to the third aspect of the invention with solely one finger or input device.

Further advantageously, the use of the controller for the method according to the first aspect of the invention is adapted to not require any visual control of the touch sensitive surface or of the controller.

Other advantageous embodiments are listed in the dependent claims as well as in the description below.

### BRIEF DESCRIPTION OF THE DRAWINGS

The invention will be better understood and objects other than those set forth above will become ap-parent from the following detailed description thereof. Such description makes reference to the annexed drawings, wherein:

FIG. 1a shows a schematic of an embodiment of a controller according to a second aspect of the invention to conduct a method according to a first aspect of the invention;

FIG. 1b shows a controller for a robot according to a second aspect of the invention to perform the method according to the first aspect of the invention;

FIG. 2a shows a schematic of how a user command (x1, y1) on a touch sensitive screen gets translated into a translational velocity \vec{tₓ} in heading direction x_{R} of a robot reference frame (x_{R},y_{R},z_{R});

FIG. 2b shows a schematic of how a user command (x1, y1) on a touch sensitive screen gets translated into to an angular velocity \vec{a_{z}}, and therefore into the robot movement of yawing around the vertical axis z_{R} of the robot reference frame (x_{R},y_{R},z_{R});

FIG. 2c shows a schematic of how a user command (x1, y1) on a touch sensitive screen gets translated into a combination of \vec{tₓ} and \vec{a_{z}};

FIG. 3a shows a coordinate system of an embodiment of a user reference frame (x, y);

FIG. 3b shows a coordinate system of an embodiment of a robot reference frame (x_{R},y_{R},z_{R}); and

FIG. 4 shows an embodiment of a user reference frame (x, y) with buffer zones.

### MODES FOR CARRYING OUT THE INVENTION

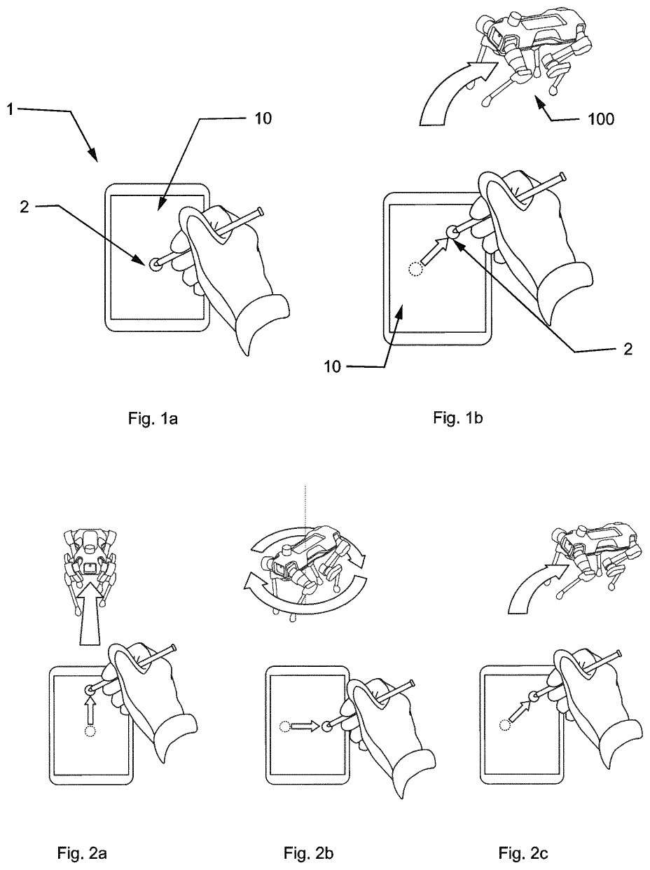

FIG. 1a shows a schematic of an embodiment of a controller according to a second aspect of the invention to conduct the method according to a first aspect of the invention.

The controller can conduct a method to control a movement of a robot 100, in particular a legged robot. The controller has a user interface unit to receive a user command for controlling a robot movement by applying an actuator command \vec{c}=f(v, w) to an actuator of the robot 100. The user interface unit comprises a touch sensitive surface 10, in particular as shown on the picture, a touch screen.

In particular, the controller is integrated into a tablet application, a smartphone application and/or a pc application as shown in FIGS. 1a and 1b.

In particular, a computer program runs on the controller, for carrying out the method according to the first aspect of the invention.

The method to control a movement of a robot 100 comprises the steps of
touching the touch sensitive surface 10 and thereby setting a new point of origin (x₀, y₀) of a user reference frame (x, y),
while staying in touch with the touch sensitive surface 10, generating a user command (x1, y1) within the user reference frame (x, y),
translating the user command (x1, y1) into the actuator command \vec{c}, with

$$v = f 1 ( y 1 )$$

$$w = f 2 ( x 1 )$$

and therefore into the robot movement, wherein v and w each correspond to one velocity, in particular correspond to different velocities, in particular correspond each to one velocity selected out of the velocities of the robot reference frame (x_{R},y_{R},z_{R})

As shown in FIG. 1b, for an advantageous embodiment of the invention, a cursor 2 can be set at the point of origin (x₀, y₀) of a user reference frame (x, y). If a finger or input device is moving on the touch sensitive surface 10, the robot moves accordingly from the point of origin (x₀, y₀) to a position of the user command (x1, y1).

Advantageously, the method might comprise the step that the movement of the robot 100 stops, as soon as a touch, respectively the finger or input device, is released or removed from the touch sensitive surface 10. This allows very easy control over the robot 100.

Further advantageously, the method might comprise the step of ignoring any further functionalities of the touch sensitive surface 10, as long as the touch, respectively the finger or input device, is not released.

Further advantageously, the touch sensitive surface might comprise a pre-defined area to set the new point of origin 2. In FIGS. 1a and 1b, this area refers to the touch sensitive surface 10 as shown in the figures.

In a further advantageous embodiment of the invention, the controller 1 or computer program can be controlled with only one finger or input device that moves over the touch sensitive surface 10, as shown in FIGS. 1a and 1b.

Therefore, no visible control of the touch sensitive surface 10 or of the controller 1 is required to interact with the robot 100.

For the FIG. 2a, 2b, and 2c, the input device (e.g. tactile pen) is positioned within the user reference frame (x, y) on the touch sensitive surface 10, here a touch screen, of a tablet device.

The first touch of the input device with the touch screen sets a new point of origin (x₀, y₀) in the user reference frame (x, y). The point of origin is indicated as dotted circle in FIG. 2a, 2b and 2\vec{c}.

The input device is then moved from the point of origin

FIG. 2a shows a schematic of how an user command (x1, y1) on a touch sensitive screen 10 gets translated into a translational velocity \vec{tₓ} in heading direction x_{R} of a robot reference frame (x_{R},y_{R},z_{R}).

FIG. 2b shows a schematic of how the user command (x1, y1) input on a touch sensitive screen 10 gets translated into an angular velocity \vec{a_{z}}, and therefore into the robot movement of yawing around the vertical axis z_{R} of the robot reference frame (x_{R},y_{R},z_{R});

FIG. 2c shows a schematic of how the user command (x1, y1) input on a touch sensitive screen gets translated into a robot movement that corresponds to a combination of \vec{tₓ} and \vec{a_{z}};

In a further advantageous embodiment of the method, not shown in the figures, the actuator command \vec{c}=f(v, w) on a touch sensitive screen gets translated translating the user command (x1, y1) into the actuator command \vec{c}, and therefore into the robot movement, wherein w corresponds to a translational velocity \vec{t_{Y}} in lateral direction y_{R} of the robot reference frame (x_{R},y_{R},z_{R}).

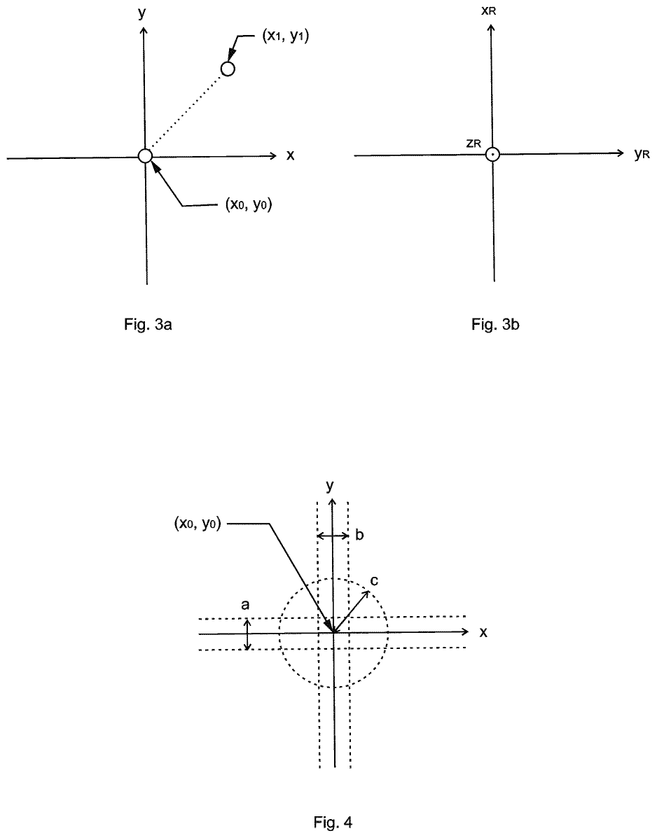

FIG. 3a shows a user reference frame (x, y). The user reference frame is advantageously integrated into the controller. In particular, the user reference frame (x, y) is displayed on a touch sensitive surface, in particular a touch screen of a tablet, a smartphone and/or pc. The user reference frame (x, y) comprises an x-axis and a y-axis.

FIG. 3b shows a robot reference frame (x_{R},y_{R},z_{R}). Advantageously, the robot reference frame has a x_{R}-Axis that corresponds to the lateral moving direction of the robot. A x_{R}-Axis of the robot reference frame corresponds to the heading direction of the robot movement. A z_{R}-Axis corresponds to a vertical axis, wherein a yawing of the robot would move the robot around this vertical axis.

In a further advantageous embodiment of the invention, wherein the controller is used to control a yawing movement of the robot, the method further comprises the step of translating the user command (x1, y1) into the actuator command \vec{c}, wherein w corresponds to an angular velocity \vec{a_{z}} and therefore into the robot movement of yawing around the vertical axis z_{R} of the robot frame.

In an advantageous embodiment of the invention, the controller is used to control a translational velocity \vec{tₓ} in heading direction x_{R} of a robot reference frame (x_{R},y_{R},z_{R}).

In an alternative advantageous method of the controller, the controller is used to control a translational movement of the robot, wherein the translation is lateral to the heading direction. This method comprises the step of translating the user command (x1, y1) into the actuator command \vec{c}, and therefore into the robot movement, wherein w corresponds to a translational velocity \vec{t_{Y}} in lateral direction y_{R} of the robot frame.

In a further advantageous embodiment of the invention, the user reference frame (x, y) is invertible, such that the user commend (x1, y1) is translated into the actuator command \vec{c} with v=−f1(y1) and w=−f1(x1).

In a further advantageous embodiment of the invention, the method comprises the step of switching between different method steps. In particular, switching between alternative method steps for translating the user command (x1, y1) into the actuator command \vec{c}, as described above. The switching between alternative method steps might be done by
touching the touch sensitive surface twice and staying in touch with the touch sensitive surface at the second touch to switch method steps, and/or
releasing the touch to the touch sensitive surface to return to the previous method step.

Further advantageously, if the touch sensitive surface 10 is a touch screen, the background colour of the touch screen and/or user reference frame (x, y) might change according to the respective alternative method step.

FIG. 4 shows an advantageous embodiment of a user reference frame (x, y), with a buffer zone a in ±y-direction along the x-axis, with a buffer zone b in ±x-direction along the y-axis, and a buffer zone \vec{c} radially around the point of origin (x₀, y₀). There might be further embodiments of the user reference frame, where the user reference frame (x, y) comprises solely a buffer zone and/or a buffer zone b and/or a buffer zone \vec{c}.

An advantageous method step for the method according to the first aspect is therefore that the user command (x1, y1) is only implemented into an actuator command \vec{c} if a movement of the cursor on the touch sensitive surface (10) extends over a buffer zone in x-direction and/or in y-direction.

Advantageously, the buffer zone
b for the user command on a ±x-axis along the y-axis of the user reference frame is: 0.005 cm≤|x|≤0.5 cm,
a for the user command on a ±y-axis along the x-axis of the user reference frame is: 0.005 cm≤|y|≤0.5 cm.

In a further advantageous embodiment of the invention, the sensitivity of the user reference frame (x, y) is adaptable such that the user command in the buffer zone b on the ±x-axis is 10 times more sensitive than the user command in the buffer zone a on the ±y-axis or vice versa, in particular wherein the user command in the buffer zone b on the ±x-axis is 2 times more sensitive than the user command in the buffer zone a of the ±y-axis or vice versa.

Further advantageously, a range of an absolute scale of the buffer zone b of the ±x-axis and/or the buffer zone a of the ±y-axis of the user reference frame (x, y) is adaptable in size.

1. A method to control a movement of a robot (100), in particular a legged robot, comprising;
a controller (1) with a user interface unit configured to receive a user command for controlling a robot movement by applying an actuator command \vec{t}=f(v, w) to an actuator of the robot (100),
wherein the user interface unit comprises a touch sensitive surface (10),
the method comprises the steps of;
touching the touch sensitive surface (10) and thereby setting a new point of origin (x₀, y₀) of a user reference frame (x, y) related to the touch sensitive surface,
while staying in touch with the touch sensitive surface (10), generating a user command (x1, y1) within the user reference frame (x, y),
translating the user command (x1, y1) into the actuator command \vec{t}=f(v, w), received by the actuator, with
v=f1(y1)
w=f2(x1)
and therefore into the robot movement, wherein v and w each correspond to one velocity selected out of the velocities that a robot can take within a robot reference frame (x_{R},y_{R},z_{R}),
comprising switching between alternative method steps:
translating the user command (x1, y1) into the actuator command \vec{t}, and therefore into the robot movement, wherein v corresponds to a translational velocity \vec{t}ₓ in heading direction x_{R} and wherein w corresponds to a translational velocity \vec{t_{Y}} in lateral direction y_{R} of the robot reference frame (x_{R}, y_{R}, z_{R}) and
translating the user command (x1, y1) into the actuator command t, wherein w corresponds to an angular velocity \vec{a_{z}}, and therefore into the robot movement of yawing around the vertical axis z_{R} of the robot reference frame (x_{R}, v_{R}, z_{R}).

2. (canceled)

3. (canceled)

4. (canceled)

5. The method according to claim 1, comprising the step of stopping the robot movement, as soon as a touch of the touch sensitive surface (10) is released.

6. The method according to claim 1, comprising the step of ignoring any further functionalities of the touch sensitive surface (10) as long as the touch is not released.

7. The method according to claim 1, wherein the user command (x1, y1) is only implemented into an actuator command \vec{t} if a movement of a cursor on the touch sensitive surface (10) extends over a buffer zone in x-direction and/or in y-direction of the user reference frame (x, y).

8. The method according to claim 7, wherein the buffer zone
for the user command on a ±x-axis of the user reference frame is: 0.005 cm≤|x1|≤0.5 cm,
for the user command on a ±y-axis of the user reference frame is: 0.005 cm≤|y1|≤0.5 cm.

9. The method according to claim 1, wherein the sensitivity of the user reference frame (x, y) is adaptable such that the user command on the ±x-axis is 10 times more sensitive than the user command on a ±y-axis, in particular wherein the user command on a ±x-axis is 2 times more sensitive than the user command of the ±y-axis.

10. The method according to claim 1, wherein a range of an absolute scale of the ±x-axis and/or the ±y-axis of the user reference frame (x, y) is adaptable in size.

11. The method according to claim 1, wherein the user reference frame (x, y) is invertible, such that the user command (x1, y1) is translated into the actuator command \vec{t} with v=−f1(y1) and w=−f1(x1).

12. The method according to claim 1, wherein the touch sensitive surface (10) comprises a pre-defined area to set the new point of origin (2).

13. The method according to claim 1, wherein switching between alternative method steps is done by
touching the touch sensitive surface (10) twice and staying in touch with the touch sensitive surface (10) at the second touch to switch method steps, and/or
releasing the touch to the touch sensitive surface (10) to return to the previous method step.

14. Method according to claim 1, wherein the touch sensitive surface (10) is a touch screen and wherein the background colour of the touch screen (10) and/or user reference frame (x, y) changes according to the respective method step, to indicate haptic feedback of the respective method step.

15. Controller (1) to conduct the method according to claim 1.

16. Controller (1) according to claim 15, wherein the controller is integrated into a tablet application, a smartphone application and/or a pc application.

17. A computer program for carrying out the method according to claim 1.

18. Use of the controller according to claim 15, with solely one finger or solely one input device.

19. Use of the controller according to claim 18, wherein a colour change provides visual feedback about the present method step.
